(19) United States
(12) Patent Application Publication
(10) Pub. No.: US 2007/0226609 A1
(43) Pub. Date: Sep. 27, 2007

(54) Information processing apparatus and method of controlling the same

(76) Inventors: Sotaro Sumitomo, Ome-shi (JP); Hironori Motoe, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/714,587

(22) Filed: Mar. 6, 2007

(30) Foreign Application Priority Data
Mar. 24, 2006 (JP) 2006-083915

(51) Int. Cl. G06F 17/00

(52) U.S. Cl. 715/522; 715/961; 715/970

(57) ABSTRACT

According to one embodiment, an information processing apparatus includes a main body, a display unit being connected to the main body so as to freely pivot and comprising a sensor, and a controller executing any one operation of turning on and turning off a power supply of the main body if the sensor detects a predetermined operation.

### CROSS-REFERENCE TO RELATED APPLICATIONS

This application is based upon and claims the benefit of priority from Japanese Patent Application No. 2006-083915, filed Mar. 24, 2006, the entire contents of which are incorporated herein by reference.

### BACKGROUND

1. Field

One embodiment of the invention relates to the present invention relates to controlling of a power supply of a notebook-type computer and, more particularly, to an information processing apparatus capable of controlling power-on/power-off in accordance with open and closed states of a display and a method of controlling the information processing apparatus.

2. Description of the Related Art

JP-A 9-120323 (KOKAI), discloses a technique of detecting an angle of a main body of a notebook-type personal computer and changing power-on/power-off of the power supply in accordance with the angle (refer to JP-A 9-120323).

According to this technique, however, an acceleration sensor is built in the main body, and cannot function unless the main body is inclined.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary a perspective view showing a notebook-type computer as an information processing apparatus according to an embodiment of the present invention;

FIG. 2 is an exemplary a block diagram showing a configuration of the notebook-type computer as the information processing apparatus according to the embodiment of the present invention;

FIG. 3 is an exemplary a flowchart showing a controlling method of the information processing apparatus according to the embodiment of the present invention;

FIG. 4 is an exemplary a flowchart showing a controlling method of the information processing apparatus according to the embodiment of the present invention;

FIG. 5 is an exemplary an illustration showing change of an active window; according to the embodiment;

FIG. 6 is an exemplary an illustration showing change of an active window; according to the embodiment;

FIG. 7 is an exemplary an illustration showing an angle of a panel to a main body; according to the embodiment;

FIG. 8 is an exemplary a perspective view showing a notebook-type tablet PC as the information processing apparatus according to another embodiment of the present invention; and

FIG. 9 is an exemplary a perspective view showing a tablet style of the notebook-type tablet PC as the information processing apparatus according to another embodiment of the present invention.

### DETAILED DESCRIPTION

Various embodiments according to the invention will be described hereinafter with reference to the accompanying drawings. In general, according to one embodiment of the invention, an information processing apparatus, comprises: a main body; a display unit being connected to the main body so as to freely pivot and comprising a sensor; and a controller executing any one operation of turning on and turning off a power supply of the main body if the sensor detects a predetermined operation.

Embodiments of the present invention will be described below with reference to the accompanying drawings.

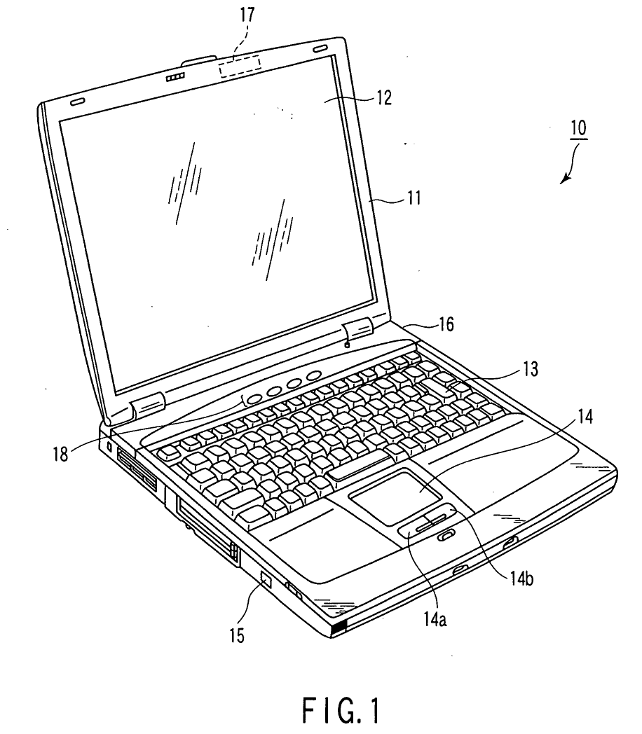

FIG. 1 is a perspective view showing an information processing apparatus according to the embodiments of the present invention. The information processing apparatus is implemented as a battery-operated notebook computer 10.

The computer 10 is composed of a main body 16 and a display unit 11 as shown in FIG. 1. A display device composed of an LCD (Liquid Crystal Display) is embedded in the display unit 11. A display screen 12 of the LCD is located approximately at the center of the display unit 11.

The display unit 11 is attached to the computer 10 so as to freely pivot between an opened position and a closed position. The main-body of the computer. 10 has a housing shaped in a thin box, and comprises a keyboard 13 on a top face, a touch pad 14 and two buttons 14a, 14b and various kinds of shortcut buttons 18 for e-mail, etc. on a palm rest. An optical drive 15 is provided on a side face of the main body 16. An acceleration sensor 17 is built in the top portion of the display unit 11.

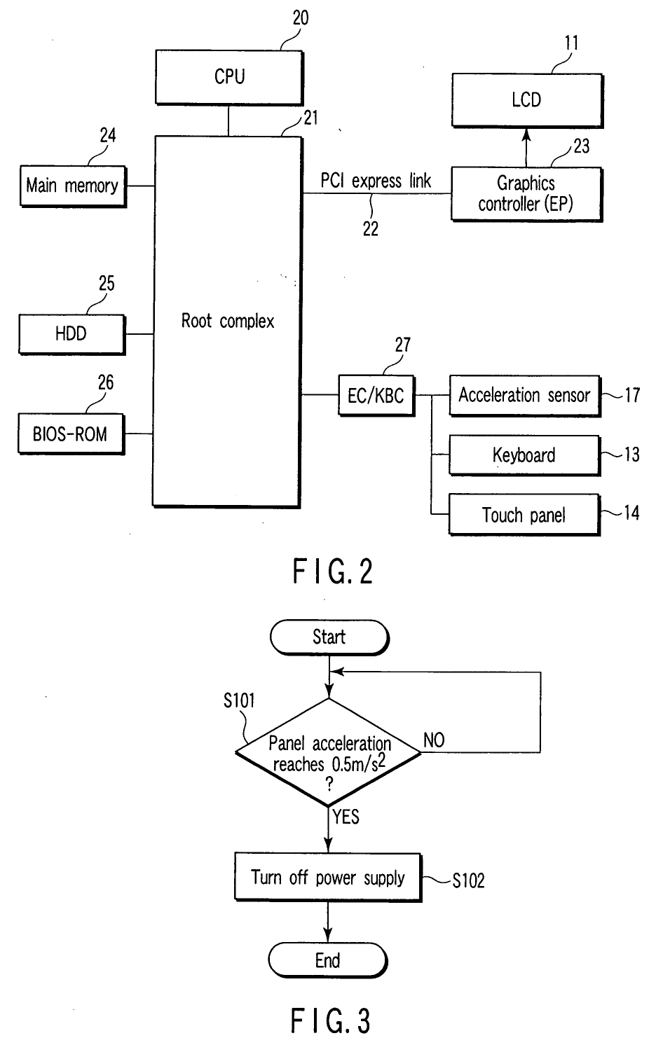

FIG. 2 is a block diagram showing the configuration of the computer.

The computer 10 comprises a CPU (Central Processing Unit) 20, a Root Complex 21, a main memory 24, a graphics controller (End. Point) 23, a PCI Express Link 22 making a connection between the Root Complex 21 and the graphics controller 23, the display unit 11, an embedded controller/keyboard controller IC (EC/KBC) 27, a hard disk drive (HDD) 25, a BIOS-ROM 26, and the acceleration sensor 17, keyboard 13 and touch pad 14 serving as input devices connected to the EC/KBC 27, etc.

The Root Complex 21, the graphics controller 23, etc. are devices in conformity with the PCI EXPRESS standards. The communications between the Root Complex 21 and the graphics controller 23 are executed over the PCI Express Link 22 arranged between the Root Complex 21 and the graphics controller 23.

The CPU 20 is a processor controlling the operations of the computer 10, and executes various kinds of programs (operating system and application systems) loaded on the main memory 24 by the HDD 25. In addition, the CPU 20 also executes the BIOS (Basic Input Output System) stored in the BIOS-ROM 26. The BIOS is a program for controlling the hardware.

The Root Complex 21 is a bridge device making a connection between a local bus of the CPU 20 and the graphics controller 23. In addition, the Root Complex 21 also has a function of executing the communications with the graphics controller 23 over the PCI Express Link 22.

The graphics controller 23 is a display controller which controls the display unit 11 employed as a display monitor of the computer.

The EC/KBC 27 is a one-chip microcomputer on which an embedded controller for power management and a keyboard controller controlling the keyboard 13 and the touch pad 14 are integrated. The EC/KBC 27 has a function of controlling power-on/power-off of the computer 10, in cooperation with a power supply controller, in response to the user's operation of the power button.

Next, a control method of the information processing apparatus according to the embodiment of the present invention is described with reference to a flowchart of FIG. 3.

In the present embodiment, an operation of closing the panel in a state in which the display unit (hereinafter called a panel) 11 is open, is described with reference to the flowchart of FIG. 3.

On the basis of the information from the acceleration sensor 17, the CPU 20 of the computer 10 discriminates whether or not an acceleration of the panel 11 has reached, for example, 0.5 m/s² (block S101). If it is discriminated in block S101 by the CPU 20 that the acceleration of the panel 11 has reached, for example, 0.5 m/s² (YES in block S101), the power of the main body 16 of the computer 10 is turned off (block S102). In general, when the power of the main body 16 of the computer 10 is turned off (shut down), the power of the display 11 is also turned off in association. Besides shutting down, shifting to standby, suspend status, etc. can be executed.

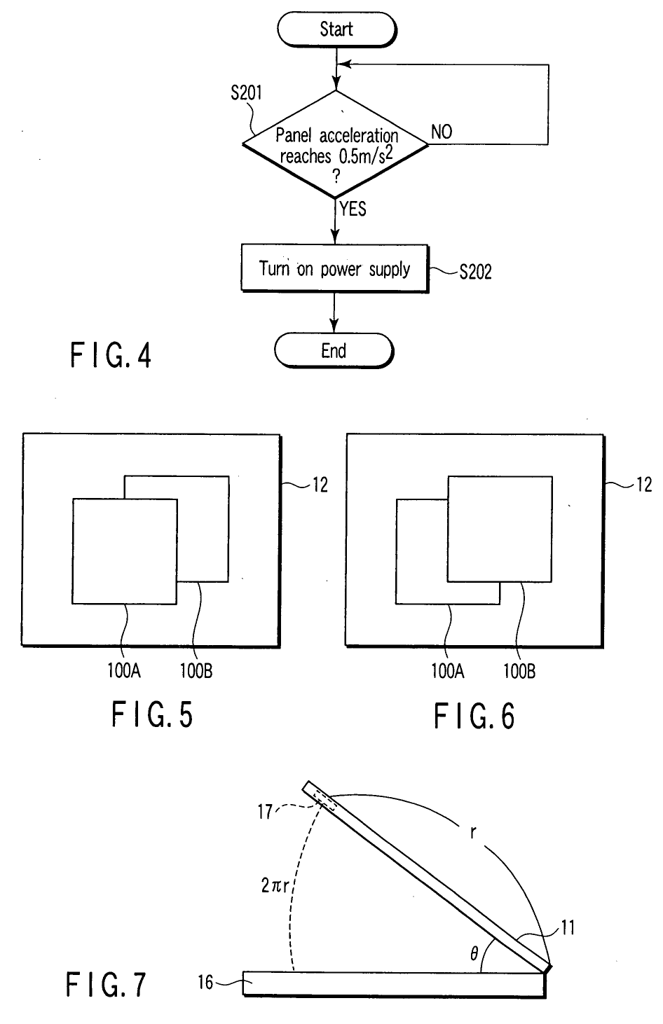

Next, operations of opening the panel 11 in the closed state are described with reference to FIG. 4.

On the basis of the information from the acceleration sensor 17, the EC/KBC 27 of the computer 10 discriminates whether or not the acceleration of the panel 11 has reached, for example, 0.5 m/s² (block S201). If it is discriminated in block S201 by the EC/KBC 27 that the acceleration of the panel 11 has reached, for example, 0.5 m/s² (YES in block S201), the power supply of the main body 16 of the computer 10 is turned on (block S202). In general, when the power supply of the main body 16 of the computer 10 is turned on, the power of the display 11 is also turned on in association.

Besides turning on/off the power supply of the main body 16 of the computer 10 in the case where the acceleration of the panel 11 has reached a predetermined value as explained above, the following operation mode is considered. For example, window 100A and window 100B are displayed on the display screen 12 of the computer 10 as shown in FIG. 5. When the window 100A is active, if the acceleration of the panel 11 has reached a predetermined value, the window 100B is switched to become active as shown in FIG. 6. Moreover, if the acceleration has reached a predetermined value, a predetermined application may be started. For example, if the acceleration has reached 0.5 m/s², e-mail software is started. If the acceleration has reached 0.7 m/s², the browser is started.

Next, an operation mode of detecting an angle between the panel 11 and the main body 16 from the acceleration detected by the acceleration sensor and turning on/off the power supply of the main body 16 of the computer 10, is explained.

The angle between the panel 11 and the main body 16 is represented as panel angle θ as shown in FIG. 7. If a length between an attachment portion of the acceleration sensor 17 and the hinge portion of the main body 16 is represented as r, the panel angle θ is represented by the following formula.

2πr+(θ/360)=at

a=acceleration, t=time

When the CPU 20 detects the panel angle θ on the basis of the acceleration detected by the acceleration sensor 17, the CPU 20 turns on or off the power supply of the main body 16 in accordance with the detected panel angle θ. For example, if the panel 11 is moved at the panel angle θ ranging from 0 to 30°, the CPU 20 turns on the power supply of the main body 16. If the panel 11 is moved at the panel angle θ ranging from 90 to 30°, the CPU 20 turns off the power supply of the main body 16.

Furthermore, if the panel angle θ becomes greater in a direction in which the panel 11 is opened at more than 30°, the CPU 20 turns on the power supply of the main body 16. If the panel angle θ becomes smaller in a direction in which the panel 11 is closed at more than 30°, the CPU 20 turns off the power supply of the main body 16.

Besides turning on/off the power supply of the main body 16 of the computer 10 in the case where the panel angle θ of the panel 11 reaches a predetermined value as explained above, the following operation mode is considered. For example, the window 100A and the window 100B are displayed on the display is screen 12 of the computer 10 as shown in FIG. 5. When the window 100A is active, if the panel angle θ of the panel 11 has reached a predetermined value, the window 100B is switched to become active as shown in FIG. 6. Moreover, if the panel angle θ has reached a predetermined value, a predetermined application may be started. For example, if the panel angle θ has reached 60°, e-mail software is started. If the panel angle θ has reached 110°, the browser is started.

According to the above embodiment, the power supply can be turned on or off in accordance with the speed and angle of the panel. In addition, the active windows can be changed or the predetermined application can be started in accordance with the speed and angle of the panel.

### Other Embodiment

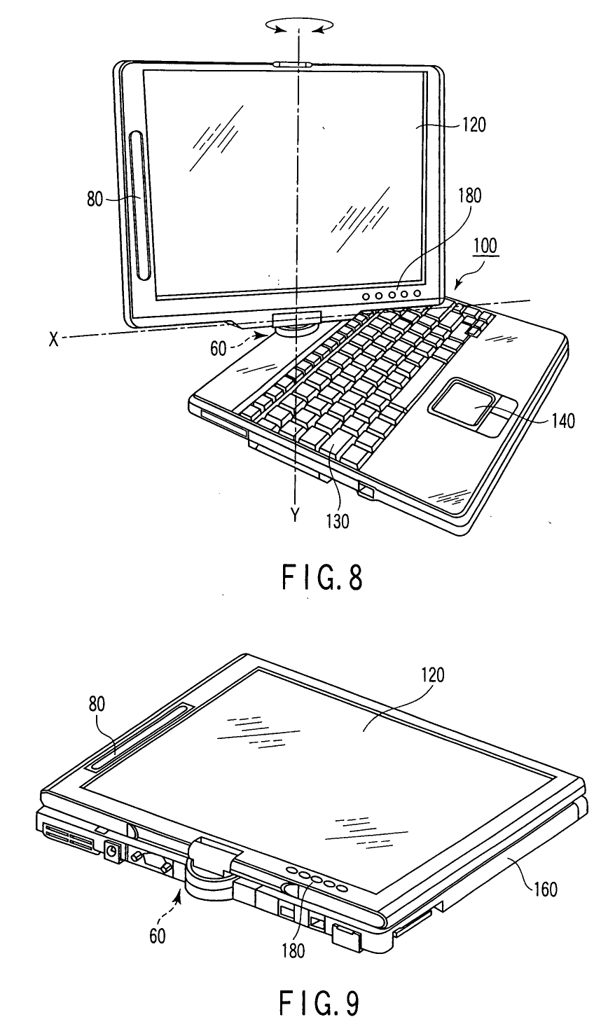

Next, a second embodiment of the present invention will be described with reference to FIG. 8 and FIG. 9.

FIG. 8 is a perspective view showing a notebook-type tablet PC as the information processing apparatus according to the other embodiment of the present invention.

A tablet PC 100 is composed of a main body comprising a keyboard 130, a touch pad 140, a hinge 60 serving as a connecting portion connected to a movable liquid-crystal display 120, etc., and the display 120 which is movably connected to the hinge 60 comprising various kinds of buttons 180. The display 120 is a touch panel, and operations can be made directly on the display 120 by using a stylus 80, etc.

The display 120 can be rotated around Y axis with the hinge 60 serving as an axis of rotation, and can be folded down around X axis. For example, if the display 120 is folded down with the display surface facing upwardly, the PC is in the tablet style as shown in FIG. 9. When the PC is in the tablet style, for example, two users can use the PC while watching the display 120.

Even when the tablet PC 100 is employed, the power supply can be turned on or off in accordance with the speed and angle of the panel as described in the above embodiment. In addition, the active windows can be changed or the predetermined application can be started in accordance with the speed and angle of the panel. The same advantages as those of the above embodiment can be obtained.

Similarly, if the PC is equipped with a device whose operations are limited in accordance with the angle between the panel 11 and the main body 16, other than the device according to the embodiment of the present invention, the advantages of the present invention can be obtained by applying the present invention to the device in the same manner.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a main body;
a display unit being connected to the main body so as to freely pivot and comprising a sensor; and
a controller executing any one operation of turning on and turning off a power supply of the main body if the sensor detects a predetermined operation.

2. The apparatus according to claim 1, wherein the sensor is an acceleration sensor, and any one operation of turning on and turning off the power supply of the main body is executed in accordance with a magnitude of acceleration detected by the acceleration sensor.

3. The apparatus according to claim 2, wherein an angle of the display unit to the main body is detected in accordance with the acceleration detected by the acceleration sensor and, if the display unit pivots from a range of a predetermined angle to a range of the other predetermined angle, any one operation of turning on and turning off the power supply of the main body is executed.

4. The apparatus according to claim 1, wherein the sensor is an acceleration sensor, and a predetermined application is started in accordance with a magnitude of acceleration detected by the acceleration sensor.

5. The apparatus according to claim 4, wherein an angle of the display unit to the main body is detected in accordance with the acceleration detected by the acceleration sensor and, if the display unit pivots from a range of a predetermined angle to a range of the other predetermined angle, the predetermined application is started.

6. The apparatus according to claim 1, wherein the sensor is an acceleration sensor, and active application, of started applications, are changed in accordance with a magnitude of acceleration detected by the acceleration sensor.

7. The apparatus according to claim 6, wherein an angle of the display unit to the main body is detected in accordance with the acceleration detected by the acceleration sensor and, if the display unit pivots from a range of a predetermined angle to a range of the other predetermined angle, the active application, of the started applications, are changed.

8. A method of controlling an information processing apparatus, the apparatus comprising a main body and a display unit being connected to the main body so as to freely pivot and comprising a sensor, the method comprising executing any one operation of turning on and turning off a power supply of the main body when the sensor detects a predetermined operation.

9. The method according to claim 8, wherein the sensor is an acceleration sensor, and wherein executing occurs in accordance with a magnitude of acceleration detected by the acceleration sensor.

10. The method according to claim 9, further comprising detecting an angle of the display unit to the main body in accordance with the acceleration detected by the acceleration sensor and, if the display unit pivots from a range of a predetermined angle to a range of the other predetermined angle, executing any one operation of turning on and turning off the power supply of the main body.
